(19) United States
(12) Patent Application Publication
(10) Pub. No.: US 2012/0158400 A1
(43) Pub. Date: Jun. 21, 2012

(54) METHODS AND SYSTEMS FOR KNOWLEDGE DISCOVERY

(76) Inventors: Martin Schmidt, Schiffweiler (DE); Mario Alfons Diwersy, Frankfurt (DE)

(21) Appl. No.: 13/320,308

(22) PCT Filed: May 14, 2010
(86) PCT No.: PCT/US10/34932

§ 371 Date: Mar. 7, 2012

Related U.S. Application Data
(60) Provisional application No. 61/178,482, filed on May 14, 2009.

(51) Int. Cl. G06F 17/27

(52) U.S. Cl. 704/9

(57) ABSTRACT

In an aspect, provided is a Natural Language Processing (NLP) workflow engine to analyze text. The engine can combine one or more independent NLP components (e.g. Tokenization, Part of Speech Tagging, Named Entity Recognition) into a meaningful processing workflow.

### CROSS-REFERENCE TO RELATED APPLICATION

This application claims benefit of and priority to U.S. Provisional Patent Application No. 61/178,482, filed May 14, 2009, which is fully incorporated herein by reference and made a part hereof.

### SUMMARY

In an aspect, provided are systems, methods and computer program product of a Natural Language Processing (NLP) workflow engine to analyze text. The engine can combine one or more independent NLP components (e.g. Tokenization, Part of Speech Tagging, Named Entity Recognition) into a meaningful processing workflow. Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an exemplary modular Natural Language Processing (NLP) engine workflow;

FIG. 2 is an exemplary NLP workflow implementing a tokenization, sentence boundary, abbreviation expansion, normalization, concept extraction components;

FIG. 3 is an exemplary NLP workflow for creating a concept fingerprint;

FIG. 4 is an exemplary NLP workflow for creating a noun phrase fingerprint;

FIG. 5 is an exemplary NLP workflow for creating a named entity fingerprint;

FIG. 6 is an exemplary NLP workflow for creating a concept relation fingerprint;

FIG. 7 is an exemplary NLP workflow for creating a qualified concept relation fingerprint;

FIG. 8 is an exemplary NLP workflow for creating a noun phrase and concept fingerprint;

FIG. 9 is a screen shot for the game, MindShooter;

FIG. 10 is another screen shot for the game, MindShooter;

FIG. 11 is another screen shot for the game, MindShooter;

FIG. 12 is a screen shot of exemplary federated search results; and

FIG. 13 is an exemplary operating environment.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description. The contents of co-pending U.S. patent application Ser. No. 12/294,589 (U.S. Pre-Grant Publication No.: 2010-0049684, published Feb. 25, 2010) and U.S. patent application Ser. No. 12/491,825 (U.S. Pre-Grant Publication No. 2010-0017431, published Jan. 21, 2010) are herein incorporated by reference in their entireties.

In one aspect, validated concepts, and groups of validated concepts, can be concepts compiled by human experts. A concept is a representation of, for example, objects, classes, properties, and relations. The methods and systems provided can distinguish the relations (Broad Term—Narrow Term) that define the relationship between more generic terms and more specific terms (for example, ‘animal’—‘cow’ where animal is the Broad Term and cow is the Narrow Term).

In one aspect, a validated concept can be a description of one or several words. The concepts, the terms that are related to the concepts (preferred term and synonyms) are defined by subject matter experts and therefore relevant to the knowledge field (e.g., medical, legal, etc.) and validated. Validated concepts, groups of validated concepts, and knowledge profiles, can have or be given an alphanumeric representation, which allows for validated concepts, groups of validated concepts, and knowledge profiles to be rapidly compared and clustered. This selection of an alphanumeric representation for a validated concept, can provide language independence. For example, a knowledge profile (described below) can be generated from an English text and the validated concepts in the English knowledge profile can be searched for in a French thesaurus (a compilation of concepts) by alphanumeric representation to generate a French knowledge profile. In another example, the English knowledge profile can be used to search a collection of French knowledge profiles using alphanumeric representation. In one aspect, the French knowledge profiles can be presented in English, which allows the user to get an impression of the contents of the knowledge sources represented by the knowledge profiles without consulting the knowledge sources in their original language. This allows for language independent knowledge discovery.

A compilation of validated concepts can be referred to as a thesaurus and represents a field of knowledge or a piece of knowledge. The thesaurus can have top-layer concepts that have related lower, or bottom, layer concepts. For example, in medical science, a disease may have many different names. However, by selecting a name for a specific disease and all different known names for that disease, the problem of missing relevant information because of a failure to use the right keyword is avoided. A group of individually ambivalent words, when they occur together in a piece of information, and particularly when they occur in each other's proximity, can represent a very clearly defined concept.

A thesaurus can be defined by human experts and can be loaded into the system. The thesaurus can be defined in various ways and can comprise the following information: a level number (the top level is 0, more specific level is 1 etc.); a preferred term (which term should be used to communicate with the user); synonym(s) (if synonyms are known they can be added); and a concept number, which is a unique number that is assigned to the concept.

Terms in a thesaurus can be defined as a “default term,” wherein the concept will be normalized and the sequence of words in the term may vary. In a further aspect, terms in a thesaurus can be defined as a “not normalized term.” Such a “not-normalized” term will not be normalized. This is useful, for instance, when names are part of the term. In yet another aspect, the terms in a thesaurus can be defined as an “exact match term.” In this aspect, the words in the exact match term must be found in exactly the same sequence as defined in the thesaurus. This is useful, for example, when symbols like genes or chemical structures are defined in the thesaurus.

In one aspect, a thesaurus can be represented in a structured datafile. As used herein, thesaurus also refers to meta-thesaurus. In thesauri, concepts are classified according to a hierarchic system of covering or generic concepts with more specific concepts ranked below them. This results in a tree-like structure of higher, covering genus concepts, branching out to more specific, species concepts.

In one aspect, a structured datafile can represent a thesaurus in one or more knowledge fields. To make quick processing possible and to improve recognition of validated concepts, the words in the structured datafile can be normalized words. In this aspect, the information within the generated knowledge profile can be converted into a list of normalized words, after which the normalized words are looked up in the structured datafile.

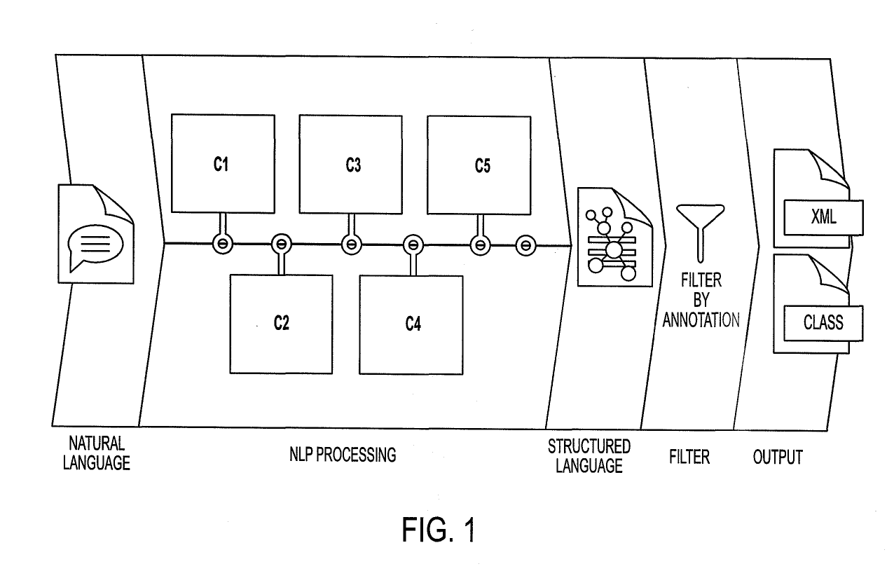

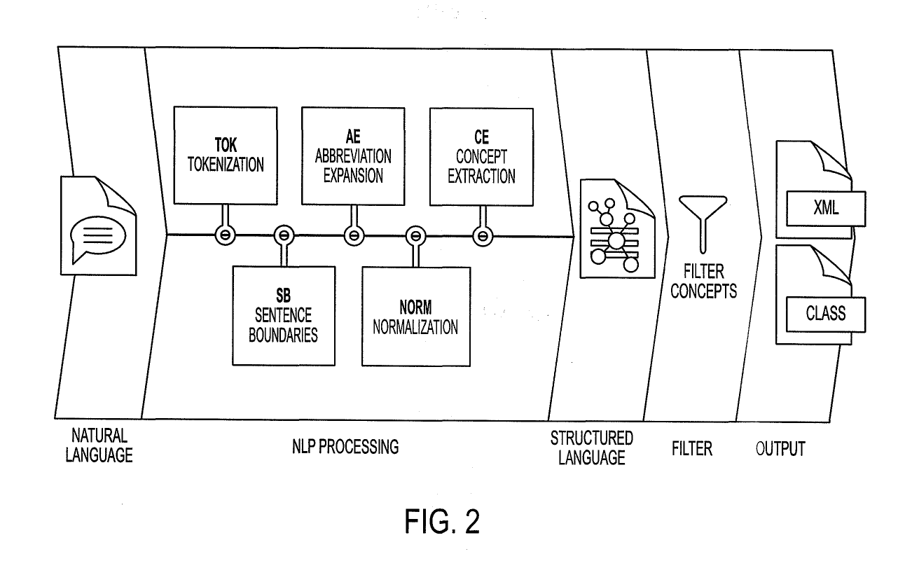

In an aspect, provided is a Natural Language Processing (NLP) workflow engine to analyze text. The engine can combine one or more independent NLP components (e.g. Tokenization, Part of Speech Tagging, Named Entity Recognition) into a meaningful processing workflow. For example, Concept Extraction can be one workflow instance of the engine and Noun Phrase Generation or Entity Recognition can be other instances of the engine. FIG. 1 illustrates an exemplary engine workflow. The components C1-C5 each represent a specific task in NLP processing. FIG. 2 illustrates a workflow implementing a tokenization, sentence boundary, abbreviation expansion, normalization, concept extraction components. Examples of text databases that can be analyzed include, but are not limited to, Pubmed (biomedical publications), Computer Retrieval of Information on Scientific Projects (“CRISP”—research grants), patent databases, legal case and statute databases, any publication database such as news related, scientific, etc . . .

The flexibility of the engine allows for the creation of knowledge fingerprints. Knowledge fingerprints can represent many different views of the same text in a particular document. For example, views can include one or more of, concept extraction, noun phrase fingerprints, named entity fingerprints, concept relation fingerprints (“C1 transmits C2”), quantified noun phrase fingerprints, and the like.

Processing components can be used based on the workflow management of the engine. For example, a thesaurus component can be used.

A tokenization component can be used. Tokenization is a basic NLP processes. The tokenization component can cut text into the most atomic parts of the language: words, punctuations, apostrophes, parenthesis etc. It is a component that can be used in preparation for other high level analyses like morphological, syntactical or semantic analyses.

A sentence boundary detection component can be used. In an aspect, after applying the tokenization component which can identify punctuation, the sentence boundary detection component can be applied to detect the next level of meaningful parts of language, sentences. Low accuracy in the sentence boundary detection component can negatively affect other high level analyses. For example, splitting text at the position of the periods in the following sentence can have negative effects: “The company could increase its turnover by 36.12% between 7 Jan. 2008 and 31 Dec. 2008, resulting in total revenue of 8.2 Million $”. Instead of 8.2 Million it would be just 2 Million $ and 12% instead of 36.12%, which could be quite a difference.

An abbreviation expansion component can be used. Especially in the world of life science, but also in many other domains, abbreviations are a very common phenomenon. Pubmed grows by approximately 100,000 abbreviations and acronyms (composed of the first letters of words) per year. This component can automatically detect short and long form combinations in a text and can also make use of a constantly growing dictionary of abbreviations.

A normalization component can be used. Normalization covers mainly the morphological tasks like stemming words to their canonical form (women/woman, children/child, walking/walk). Part of Speech Tagging

A part-of-speech (POS) tagger component can be used. The POS of a word represents its syntactical function in a text. The POS tagger component can identify the different “roles” of each word, such as noun, verb, or adjective. In an aspect, an implementation of a Hidden Markov Model can be used. This aspect can use a training set to “learn” the patterns for judging the role of a word.

A noun phrase extraction component can be used. This component can make use of the results of POS tagging and can identify single words or groups of words as meaningful phrases. A sample pattern can be “Adjective/Noun/Noun” e.g. “Extraordinary Court Decision”. Noun phrases can play a role in domains lacking proper thesauri. By applying these extractions to a solid document body in combination with statistical analyses, semi automatic thesaurus generation or thesaurus expansion will be facilitated.

A concept extraction component can be used. In an aspect, this component can represents a main task of a thesaurus component. Based on an underlying thesaurus or controlled vocabulary the concept extraction component can extract thesaurus concepts or vocabulary entries out of a given text.

A named entity recognition component can be used. This component can extract standard named entities like people and organization names, cities, countries, dollar amounts, case numbers, dates, telephone numbers, email addresses etc. Higher disciplines like protein names or gene names can also be extracted.

A relation extraction component can be used. Based on the information provided by the named entity recognition component and concept extraction component, the relation extraction component can address relations between two or more entities or concepts. In contrary to “pure” co-occurrence, which indicates a loose relation between two concepts/entities appearing in the same text, the relation extraction component can detect qualified relations like “A is a variant of B” or “A causes B”. The relation extraction component can be used for hypothesis extraction and generation.

A quantifier detection component can be used. In many cases, meaning is not expressed explicitly. Negations like “Hepatitis X is not a disease of the liver” are only one instance of quantification. Authors can quantify their opinions in compounded expressions, “in many cases the drug B has a positive effect on disease A.” The quantifier detection component can detect and use this quantification information to extract meaning.

An anaphora resolution component can be used. As with quantification, an explicit noun is not used, but is referred to: “Penicillin is a drug. It helps people with headaches.” The word “it” represents “Penicillin,” but the relation between “Penicillin” and “headaches” can be detected by the anaphora resolution component.

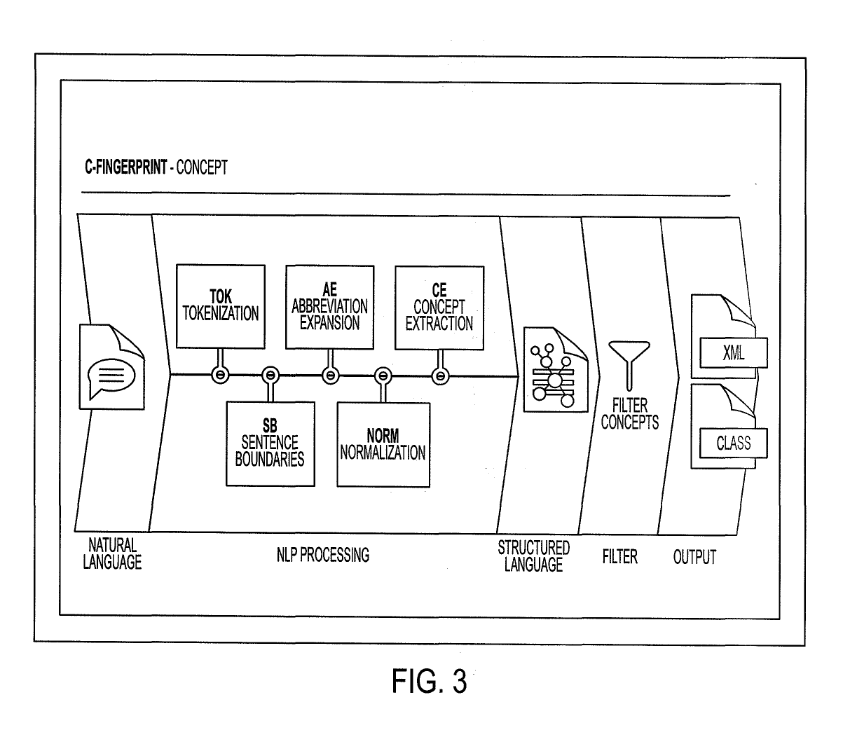

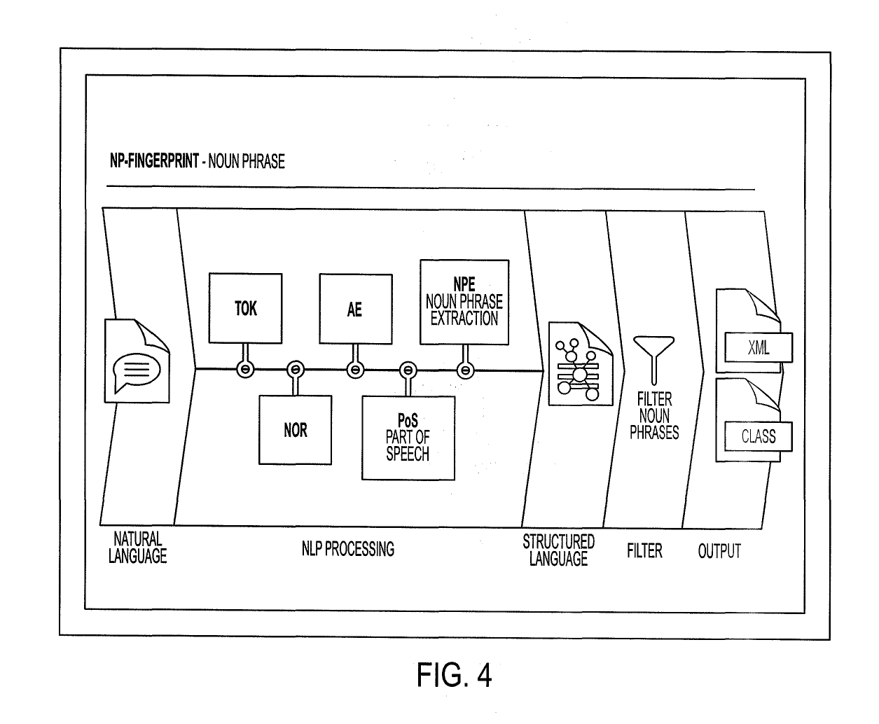

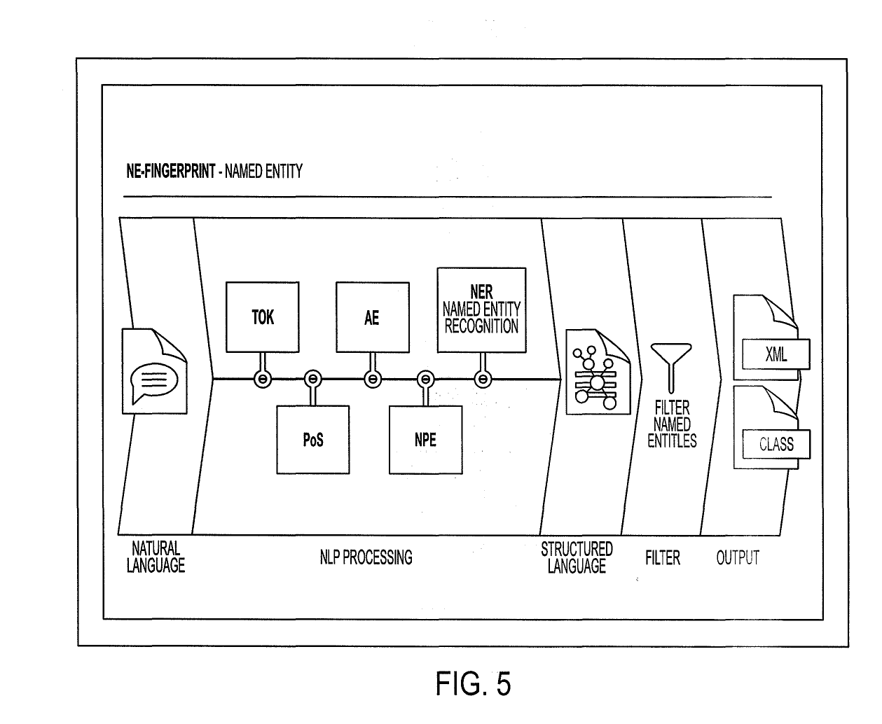

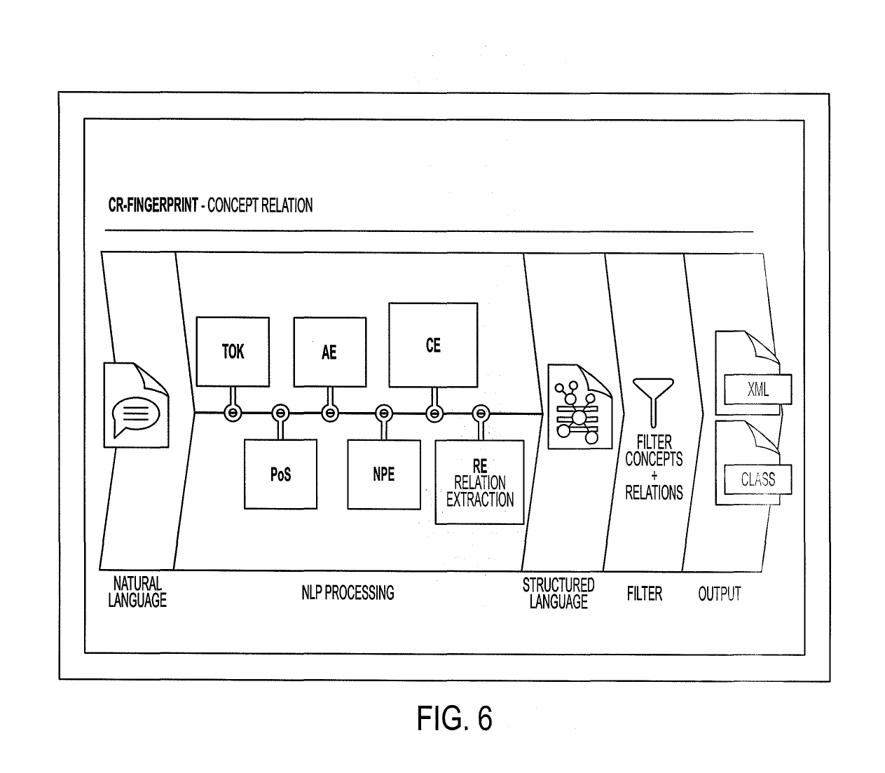

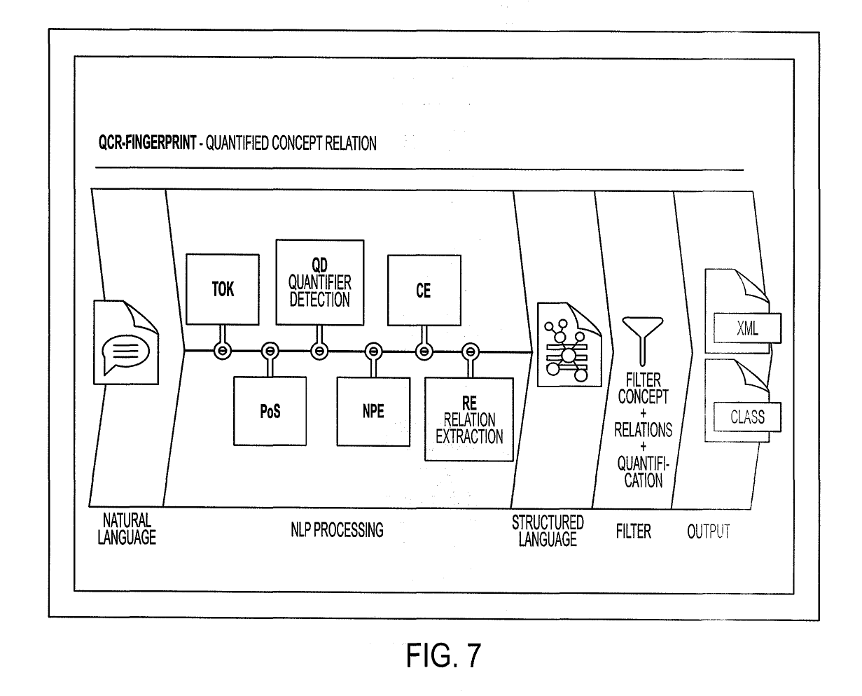

In an aspect, one or more different knowledge fingerprints can be generated based on a selected workflow. FIG. 3-FIG. 7 illustrate various workflows that generate different types of knowledge fingerprints derived from a text. FIG. 3 illustrates processing a text through the tokenization component, the sentence boundary component, the abbreviation expansion component, the normalization component, resulting in a concept fingerprint. FIG. 4 illustrates processing a text through the tokenization component, the normalization component, the abbreviation expansion component, the part of speech component, and the noun phrase extraction component, resulting in a noun-phrase fingerprint. FIG. 5 illustrates processing a text through the tokenization component, the part of speech component, the abbreviation expansion component, the noun phrase extraction component, and the named entity recognition component, resulting in a named-entity fingerprint. FIG. 6 illustrates processing a text through the tokenization component, the part of speech component, the abbreviation expansion component, the noun phrase extraction component, the concept extraction component, and the relation extraction component, resulting in a named-entity fingerprint. FIG. 7 illustrates processing a text through the tokenization component, the part of speech component, the quantifier detection component, the noun phrase extraction component, the concept extraction component, and the relation extraction component, resulting in a quantified-concept relation (QCR) fingerprint.

One or more tools can be used with the workflows provided herein. For example, in the areas of bulk processing of large text bodies and document repositories and statistical analyses of aggregated data.

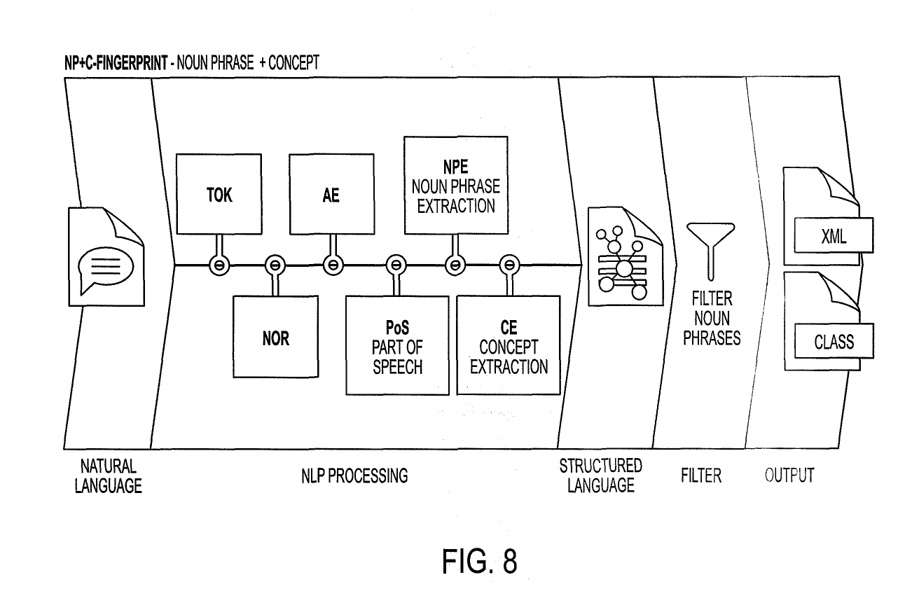

A concept candidate generator tool can be used. In an aspect, this tool can utilize the Noun Phrase Extraction workflow. The tool can extract lists of noun phrases from a text body of a particular domain (e.g. Physics, Modeling, Bankruptcy) and store the lists in an appropriate format for statistical analyses. The result of the statistical analyses can be a proper list of domain specific noun phrases that can be used as a “first generation” controlled vocabulary or as starting point for a domain thesaurus. The concept candidate generator can be used to generate a candidate list to extend an existing thesaurus by comparing the candidates against existing concepts and by parallel concept extraction during the extraction of the noun phrases. With the flexibility of the methods and systems disclosed, this parallel concept extraction can be accomplished by adding the concept extraction component to the noun phrase workflow as shown in FIG. 8.

A concept relation generator tool can be used. This tool can analyze relations between concepts based on larger domain specific text bodies. People express relations in their publications, legal cases, books etc. so that theoretically a significantly large body of information contains all the information of a domain ontology. Leveraging this information is the main functionality of the concept relation generator. Statistical analyses can be applied to the results.

In an aspect, provided are various applications of the data derived from the workflows described herein. In one aspect, provided is an association game, referred to herein as “MindShooter”. MindShooter can address researchers' affinity to playing, creativity and their continued drive to associate things. The game has a high degree of intellectual claim and can be focused on the scientific world the researcher lives in, be it his/her own expertise like “bone neoplasm” or be it another experts mind like a professor or a speaker at a conference.

As previously described a Pubmed Fingerprint set can be generated for each title and each sentence of an abstract for all Pubmed records. Concepts mentioned together in a sentence or even in the title can be deemed to have a high degree of relationship and can be seen as an association a person has made in the article. This data can be used to produce many pairs of concepts, for example, disease-drug or drug-drug, and/or disease-disease.

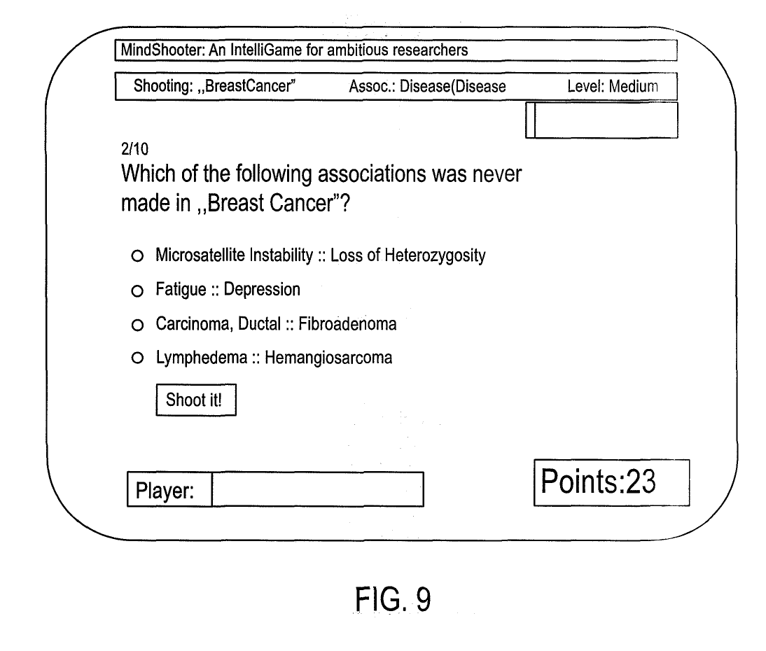

A player can first be asked to define the scientific area by selecting a concept e.g. “bone neoplasm” or by selecting an expert e.g. Prof. Karl-Heinz Kuck. In addition the player can select the level of difficulty from “easy” to “hard.” The system can generate a list of concept pairs. In addition the system can generate a second list of pairs, never before associated in Pubmed, but related to the user's selection. The user can be asked to identify which associations are “established,” meaning, being found in at least one publication, and which ones the system fabricated. FIG. 9 illustrates an exemplary screen shot.

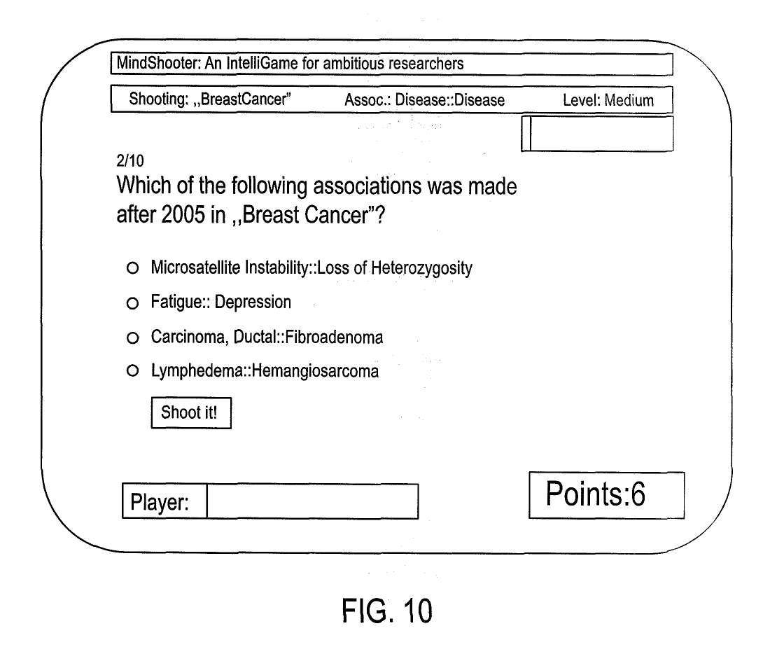

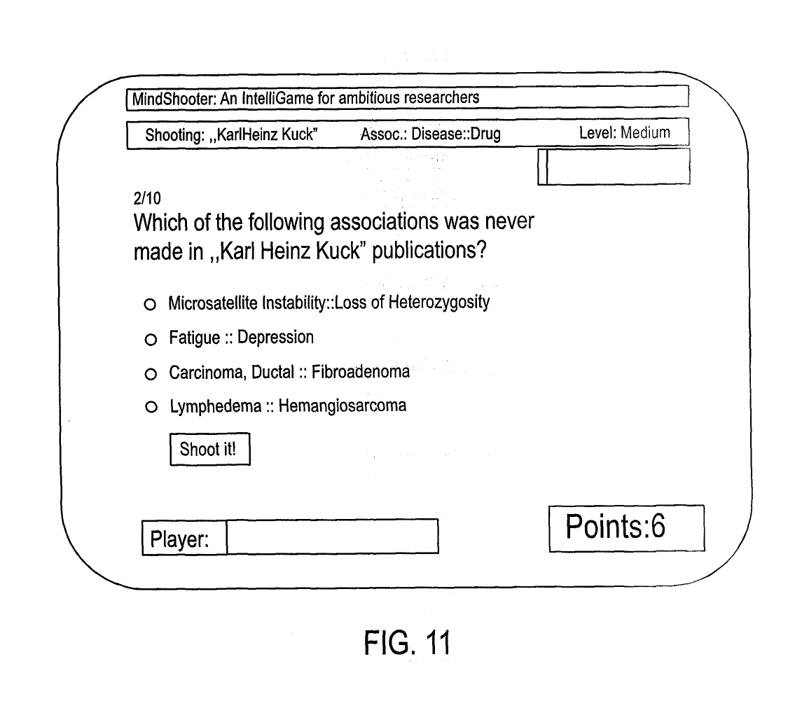

FIG. 10 illustrates a variation where the user is asked to predict at what point in time an association was made. FIG. 11 illustrates a screenshot where students are asked questions based on the knowledge of their professor. After having identified the correct answer, the user can be provided with background information on the association. For example, citation information, related experts, and the like. In an aspect, the game can be used on mobile devices.

Visualization of concept information, relations, connections and many other data plays a role in the user experience. The experiences with BiomedExperts' NetworkViewer and GeoViewer have shown how much attention can be generated in the market. Visualization examples include, but are not limited to, trend visualization, social networks, thesaurus and ontology visualization, world maps, country maps, city maps, and network clustering

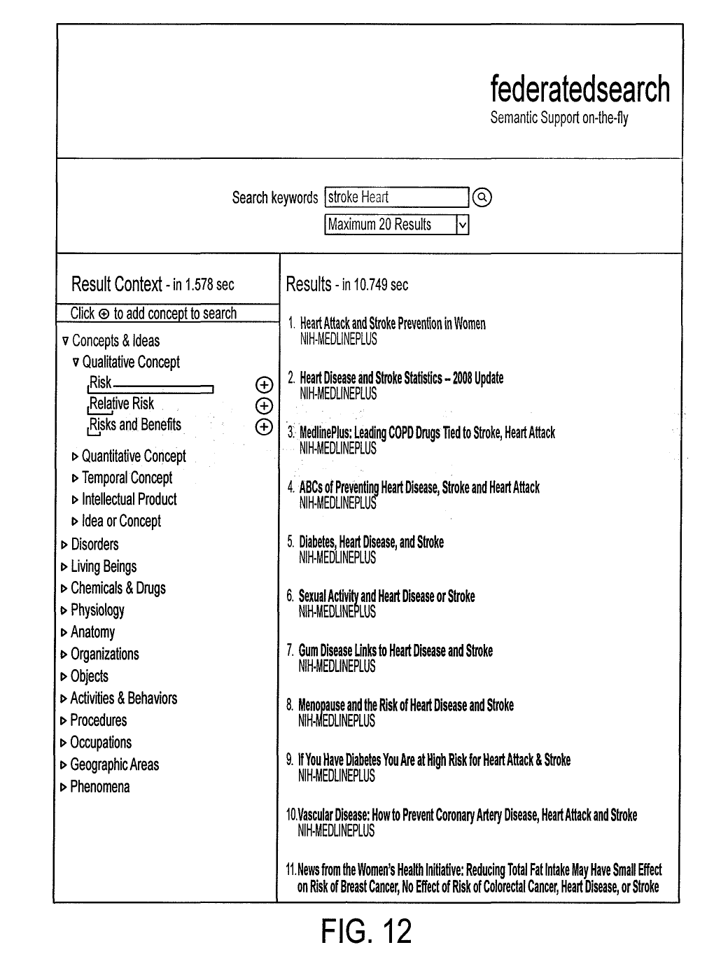

In another aspect, the methods and systems can implement a federated search. A user can enter a search query and the federated search engine can access in the background a series of other search engines or databases and return a defined number of top results including abstracts or first paragraphs The concept extractor can use the delivered text to extract thesaurus concepts. The result pages of the search can then be enriched with the identified concepts and can be organized in thesaurus structures. An exemplary screen shot is shown in FIG. 12.

In another aspect, the methods and systems can implement a reviewer finder application. Utilizing a large network of expert data and geo analyses data, the reviewer finder allows for the identification of experts using a similarity search based on concept fingerprints. For example, the methods and systems can generate a concept fingerprint for a grant proposal and conduct a search using the concept fingerprint to find the reviewers with similar expertise. It is also possible to identify different kinds of conflicts of interest. Conflicts can be detected if the potential reviewer is a direct or indirect coauthor of the applicant or if they are active at the same location. This model is also applicable to the publication peer review process.

In another aspect, the methods and systems can implement an opinion leader finder application. The opinion leader finder application can identify key researchers in a particular area based on a certain concept fingerprint. The functionality can be extended by time line analyses, to identify “early leaders” or “early inventors.”

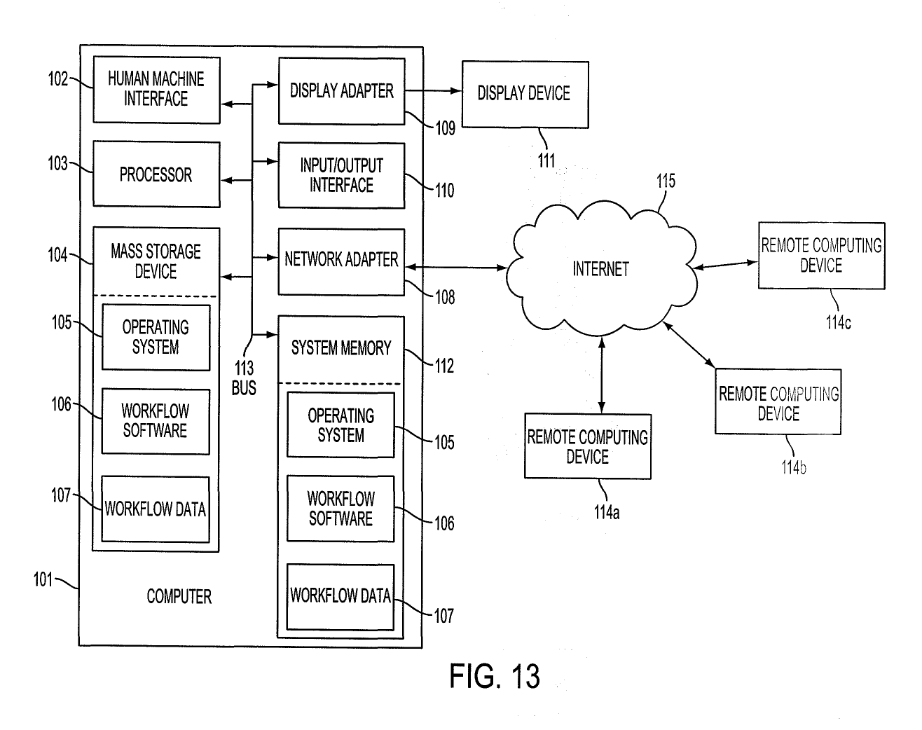

FIG. 13 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 1301. The components of the computer 1301 can comprise, but are not limited to, one or more processors or processing units 1303, a system memory 112, and a system bus 113 that couples various system components including the processor 1303 to the system memory 112. In the case of multiple processing units 1303, the system can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 1303, a mass storage device 1304, an operating system 1305, workflow software 1306, workflow data 1307, a network adapter 1308, system memory 112, an Input/Output Interface 110, a display adapter 1309, a display device 111, and a human machine interface 1302, can be contained within one or more remote computing devices 114a,b,c at physically separate locations, connected through buses of this form, in effect implementing a fully distributed system.

The computer 1301 typically comprises a variety of computer readable media. Exemplary readable media can be any available media that is accessible by the computer 1301 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as workflow data 1307 and/or program modules such as operating system 1305 and workflow software 1306 that are immediately accessible to and/or are presently operated on by the processing unit 1303.

In another aspect, the computer 1301 can also comprise other removable/non-removable, volatile/non-volatile computer storage media. By way of example, FIG. 13 illustrates a mass storage device 1304 which can provide non-volatile storage of computer code, computer readable instructions, data structures, program modules, and other data for the computer 1301. For example and not meant to be limiting, a mass storage device 1304 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 1304, including by way of example, an operating system 1305 and workflow software 1306. Each of the operating system 1305 and workflow software 1306 (or some combination thereof) can comprise elements of the programming and the workflow software 1306. Workflow software 1306 executed by the processor 1303 can comprise a workflow engine. Workflow data 1307 can also be stored on the mass storage device 1304. Workflow data 1307 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 1301 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 1303 via a human machine interface 1302 that is coupled to the system bus 113, but can be connected by other interface and bus structures, such as a parallel port, game port, an IEEE 1394 Port (also known as a Firewire port), a serial port, or a universal serial bus (USB).

In yet another aspect, a display device 111 can also be connected to the system bus 113 via an interface, such as a display adapter 1309. It is contemplated that the computer 1301 can have more than one display adapter 1309 and the computer 1301 can have more than one display device 111. For example, a display device can be a monitor, an LCD (Liquid Crystal Display), or a projector. In addition to the display device 111, other output peripheral devices can comprise components such as speakers (not shown) and a printer (not shown) which can be connected to the computer 1301 via Input/Output Interface 110. Any step and/or result of the methods can be output in any form to an output device. Such output can be any form of visual representation, including, but not limited to, textual, graphical, animation, audio, tactile, and the like.

The computer 1301 can operate in a networked environment using logical connections to one or more remote computing devices 114a,b,c. By way of example, a remote computing device can be a personal computer, portable computer, a server, a router, a network computer, a peer device or other common network node, and so on. Logical connections between the computer 1301 and a remote computing device 114a,b,c can be made via a local area network (LAN) and a general wide area network (WAN). Such network connections can be through a network adapter 1308. A network adapter 1308 can be implemented in both wired and wireless environments. Such networking environments are conventional and commonplace in offices, enterprise-wide computer networks, intranets, and the Internet 115.

For purposes of illustration, application programs and other executable program components such as the operating system 1305 are illustrated herein as discrete blocks, although it is recognized that such programs and components reside at various times in different storage components of the computing device 1301, and are executed by the data processor(s) of the computer. An implementation of workflow software 1306 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method of textual analysis comprising:
analyzing text using a processor comprising a workflow engine, wherein said workflow engine comprises at least a thesaurus component, said thesaurus component comprising a structured datafile of words related to a knowledge field;
creating a knowledge fingerprint of the text using said text analysis.

2. The method of claim 1, wherein said workflow engine comprises one or more additional components.

3. The method of claim 2, wherein the one or more additional components can include one or more of a tokenization component, a sentence boundary detection component, an abbreviation expansion component, a normalization component, a part-of-speech (POS) tagger component, a noun phrase extraction component, a concept extraction component, a named entity recognition component, a relation extraction component, a quantifier detection component, or an anaphora resolution component.

4. The method of claim 3, wherein one or more different knowledge footprints are created by said workflow engine.

5. The method of claim 3, wherein a different knowledge footprint is created by each component that comprises said workflow engine.

6. The method of claim 1, wherein the thesaurus component comprises a compilation of validated concepts representing a field of knowledge or a piece of knowledge organized into the structured datafile of words related to a knowledge field.

7. The method of claim 1, wherein said thesaurus component comprises a structured datafile of normalized words related to a knowledge field.

8. A system for textual analysis comprised of:
a memory; and
a processor operably connected with said memory, wherein said processor is configured to,
analyze text using a workflow engine, wherein said workflow engine comprises at least a thesaurus component, said thesaurus component comprising a structured datafile of words related to a knowledge field stored in said memory; and
create a knowledge fingerprint of the text using said text analysis.

9. The system of claim 8, wherein said workflow engine comprises one or more additional components.

10. The system of claim 9, wherein the one or more additional components can include one or more of a tokenization component, a sentence boundary detection component, an abbreviation expansion component, a normalization component, a part-of-speech (POS) tagger component, a noun phrase extraction component, a concept extraction component, a named entity recognition component, a relation extraction component, a quantifier detection component, or an anaphora resolution component.

11. The system of claim 10, wherein one or more different knowledge footprints are created by said workflow engine.

12. The system of claim 10, wherein a different knowledge footprint is created by each component that comprises said workflow engine.

13. The system of claim 8, wherein the thesaurus component comprises a compilation of validated concepts representing a field of knowledge or a piece of knowledge organized into the structured datafile of words related to a knowledge field.

14. The system of claim 8, wherein said thesaurus component comprises a structured datafile of normalized words related to a knowledge field.

15. A computer program product comprising at least one non-transitory computer-readable storage medium having computer-readable program code portions for textual analysis stored therein, said computer-readable program code portions comprising:
a first portion for analyzing text using a processor comprising a workflow engine, wherein said workflow engine comprises at least a thesaurus component, said thesaurus component comprising a structured datafile of words related to a knowledge field; and
a second portion creating a knowledge fingerprint of the text using said text analysis.

16. The computer program product of claim 15, wherein said workflow engine comprises one or more additional components.

17. The computer program product of claim 16, wherein the one or more additional components can include one or more of a tokenization component, a sentence boundary detection component, an abbreviation expansion component, a normalization component, a part-of-speech (POS) tagger component, a noun phrase extraction component, a concept extraction component, a named entity recognition component, a relation extraction component, a quantifier detection component, or an anaphora resolution component.

18. The computer program product of claim 17, wherein one or more different knowledge footprints are created by said workflow engine.

19. The computer program product of claim 17, wherein a different knowledge footprint is created by each component that comprises said workflow engine.

20. The computer program product of claim 15, wherein the thesaurus component comprises a compilation of validated concepts representing a field of knowledge or a piece of knowledge organized into the structured datafile of words related to a knowledge field.

21. The computer program product of claim 15, wherein said thesaurus component comprises a structured datafile of normalized words related to a knowledge field.
